(19) United States
(12) Patent Application Publication
(10) Pub. No.: US 2014/0304106 A1
(43) Pub. Date: Oct. 9, 2014

(54) SYSTEMS AND METHODS FOR DETERMINING ATTRIBUTE-BASED USER PREFERENCES AND APPLYING THEM TO MAKE RECOMMENDATIONS

(71) Applicant: LogiPref, Inc., Boston, MA (US)

(72) Inventor: Eliav Dahan, Boston, MA (US)

(21) Appl. No.: 14/203,936

(22) Filed: Mar. 11, 2014

Related U.S. Application Data
(60) Provisional application No. 61/789,056, filed on Mar. 15, 2013.

(51) Int. Cl. G06Q 30/06

(52) U.S. Cl. CPC G06Q 30/0631
USPC 705/26.7

(57) ABSTRACT

Embodiments provide recommendations. A set of stimuli for an item type is generated by identifying a plurality of items corresponding to the item type, a set of objective and/or subjective attributes associated with the item type, and levels corresponding to at least a portion of the set of attributes for the plurality of items. Utility functions are generated in which a given attribute in the set of attributes is associated with a weighting indicating a relative importance of given attribute to a respective simulated consumer. A set of items is selected and presented to a user. A user indication is received as to which item in the set is a most preferred item and/or which item in the set of items is a least preferred item. A utility function is selected from the plurality of utility functions. Item ranking scores are generated using the selected utility function.

### BACKGROUND OF THE INVENTION

1. Field of the Invention

The present invention is related to providing recommendations, and in particular, to methods and systems for dynamically generating recommendations based on attribute-based preferences.

2. Description of the Related Art

Conventional techniques for providing product and service recommendations to users, based on user preferences and needs, are often insufficiently accurate. Further, conventional techniques for determining user preferences and needs often require expensive and time consuming surveys of large numbers of people, the use of focus groups, collaborative filtering based on other consumers' prior choices, and other such cumbersome techniques.

### SUMMARY OF THE INVENTION

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

Embodiments described herein provide recommendations for products and services to users. Certain embodiments disclosed herein assist users with respect to complex decisions by quickly measuring a user's preferences and utilizing an attribute-based rule that reflects those preferences and that incorporates the tradeoffs the user would or is likely to make, and ranking applicable products and services using the rule.

Certain embodiments determine heterogeneous preferences for a population. Certain embodiments partition a product or service into a set of objective and/or subjective attributes. The objective attributes may be obtained from a variety of sources, such as product advertising, sales information, and/or product information. Subjective attributes may also be obtained from a variety of sources, such as a preferences of crowds game, discussed below. Certain embodiments provide a user with choices of several existing options with respect to a product type or service type for which a recommendation is sought, and asks the user which is the user's most preferred choice (optionally of a small, finite set such as three to five choice options), or asks the user which is the user's least preferred choice, or asks the user to select both which is the user's most preferred choice and which is the user's least preferred choice. The foregoing question and choice process may be used to determine and infer how important various product or service attributes are to the user. Based at least in part on the user's selection(s), a subsequent selection of choices may be dynamically and adaptively generated from which the user is to choose. The foregoing may be repeated multiple times such that subsequent choice sets take into account some or all prior choices made. Based at least in part on the user's selection(s), a rule may be selected from a plurality of predefined rules that closely corresponds to the choices made by the user. The selected rule is applied to products or services of the relevant product or service type. A ranked list of products or services may be generated and some or the entire ranked list may be transmitted to or otherwise provided to the user. Optionally, a report may be generated which indicates what product/service attributes the process has determined are important to the user and which product/service attributes are unimportant to the user. Further, manual modifications to the rules such as “must haves” and/or “must not haves” may optionally be applied to narrow or reorder the ranked list of products or services recommended. Certain embodiments optionally employ a preferences of crowds game in order to obtain subjective, information from large numbers of people. For example, certain embodiments encourage users to participate in surveys by turning the surveys into a game. Survey participants may allocate across a plurality of products or services based on their personal perception of beauty (or any other subjective attribute), and may be offered rewards for guessing or estimating what other people would subjectively think or value regarding certain attributes in order to create subjective attribute levels.

### BRIEF DESCRIPTION OF THE DRAWINGS

Embodiments will now be described with reference to the drawings summarized below. These drawings and the associated description are provided to illustrate example embodiments, and not to limit the scope of the invention.

FIG. 1 illustrates an example system architecture.

FIG. 2 illustrates an example process.

FIG. 3 illustrates another example process.

### DETAILED DESCRIPTION OF PREFERRED EMBODIMENTS

Embodiments described herein provide recommendations for products and/or services to users. Certain embodiments do not require the use of surveys of large numbers of people or focus groups (although such may be used to enhance accuracy or improve speed, or both). Further, the recommendations may be personalized for a given user without requiring the user to answer large numbers of questions.

Different people differentially weigh various features with respect to products, services, medical treatments, and the like. For example, with respect to houses, for some people views may be a very important consideration, while for others, views may not be very important, but having a pool may be a very important consideration. By way of further example, with respect to television sets, for some people the number of inputs may be very important, while for others the presence of Internet capability or a remote keyboard may be more important. By way of still further example, with respect to medical treatments, some patients would like to avoid surgery unless absolutely necessary, and would instead prefer months of therapy to treat a condition (e.g., an orthopedic condition). Other patients may much prefer surgery if having surgery will greatly reduce the amount of subsequent time-consuming therapy.

Certain embodiments determine heterogeneous preferences for a population. By way of example, certain preferences may be determined in part by gathering observations of the market (e.g., unit sales and average price per product) for a given type of good or service. Such observations may be used to infer a distribution of preferences and randomly draw sets of preferences (wherein a given set of preferences represents a theoretical “person”) from that distribution. Such random person may be mapped to existing products based on probability of buying, that is, how likely the person is to buy a product. Preferences may be positive preferences (e.g., attributes that a person wants in a product or service) or negative preferences (attributes that a user does not want in a product or service). Even lacking embodiments based on market data, such as unit sales, observation of product or service variety can be used to infer and measure preference heterogeneity.

People make choices at least partially based on perceived benefits that derive from bundles of attribute levels of available options. Therefore, certain embodiments described herein divide a product or service into a set of attributes. Each attribute may optionally be independently weighted so that different attributes may have different weightings for different individuals. The weighting may optionally be measured based on consumer surveys regarding what attributes they find important or unimportant and/or product/service sales data, and or product/service usage data. By way of example, an individual choosing a snack to consume may put a greater weight on sweetness, crunchiness and brand name, and therefore prefer Skittles candy out of hundreds of options, while a different individual may prioritize tartness, soft and smooth mouth feel, healthiness and cooler temperature, and therefore prefer Fage Greek Yogurt out of hundreds of options.

Attributes can include objective, quantifiable criteria (e.g., price, number of bedrooms, square footage for a house; price, diagonal dimensions, and display type for a television, etc.) and emotional/subjective, qualitative criteria (e.g., beautiful, modern, elegant, etc.). Information regarding the various attributes may be gathered from one or more sources and/or may be measured. For example, each subjective, emotional criterion may optionally be measured independently.

The objective attributes may be obtained from a variety of sources. For example, advertising literature provided by the manufacturers or retailers of a given product may be used to identify and/or weight attributes that the manufacturer or retailer believes is important to users. By way of example, if advertisements for televisions tend to emphasize the diagonal size, technology (LCD, plasma, etc.), and the number of pixels, reflecting the importance that manufactures believe consumers place on such features, then those attributes may be selected and/or relatively more heavily weighted. By way of a further example, the nutrition labels on snacks may be objectively observed and analyzed to determine average calories per serving across some or all snacks, the relative caloric contribution from fats, carbohydrates and proteins, etc.

Similarly, publically available sale information may be accessed and utilized to determine what attributes are important. For example, if two similar models of televisions are available, differentiated in that one offers Internet access and one does not, but the one with Internet access sells three times as many units as the one without Internet access, then it can be inferred that the significant difference in sales is attributable in large part to the inclusion of Internet access. Therefore, Internet access may be weighted as an important attribute. With respect to medical treatment, objective attributes may be obtained from medical research reports (e.g., reports that discuss the measured negative and positive results of a given medical treatment and the likelihood of such positive or negative results), and so on.

The foregoing approach also may take into account that subjective/emotional attribute levels or weightings for a given item (e.g., a product or service) often vary from person to person. For example, while a large majority of people may think a given product is beautiful, a given individual may think that the product is ugly. Certain embodiments “type” people to solve this problem to a significant level of detail.

As will be described in greater detail below, individual preferences can be quantified through a scoring rule, or utility function, in which a given attribute is assigned an importance or weighting coefficient to indicate the relative importance of that particular attribute. The higher a particular option scores using an individual's scoring rule, the more likely that individual will select that particular option. Certain embodiments generate customized recommendations for a user by ranking relevant products by selecting a predefined rule based on a given user's determined and/or inferred personal preferences as measured by choices they make.

Certain embodiments provide a user with discrete choices of several existing options with respect to a product type or service type for which a recommendation is sought, and asks the user which is the user's most preferred choice, or asks the user which is the user's least preferred choice, or asks the user to select both which is the user's most preferred choice and which is the user's least preferred choice. Based at least in part on the user's selection(s), a further selection of choices may be dynamically generated from which the user is to choose. The foregoing may be repeated two or more times. Based at least in part on the user's selection, a rule is selected from a plurality of predefined rules, wherein the selected rule closely or exactly ranks the products or services consistently with the choices made by the user. The selected rule is applied which ranks respective products or services.

In certain embodiments, the rule may be used to rank all applicable products or services that have been identified. By way of illustrative example, consider the choice of a snack out of 825 possible snacks. A predefined rule might be (with each attribute rated on 0-1 continuous scale):

$$Snack Total Utility = ( weighting coefficent 1 ) * Sweetness + ( weighting coefficent 2 ) * Tartness - ( weighting coefficent 3 ) * Chocolatiness + ( weighting coefficent 4 ) * Hardness / Cruchiness + ( weighting coefficent 5 ) * Easiness + ( weighting coefficent 6 ) * Warmth + ( weighting coefficent 7 ) * Economical - ( weighting coefficent 8 ) * Healthness + ( weighting coefficent 9 ) * Brand Awareness$$

Such a rule may rank Skittles candy at the top of the preferred list, with Lifesavers as the second most preferred option. At the bottom of the list of preferred snacks might be Better Bowls Instant Pudding Chocolate Gluten & Sugar Free w/Splenda and Low Fat Skinny Cow Chocolate Ice Cream Cones with Fudge.

A ranked list of products or services may be generated and some or all of the ranked list may be transmitted to or otherwise provided to the user. The products or services that are determined to be relatively more suitable for the user may be listed towards the top of the ranked list, while those that are considered less suitable may be listed lower down. Thus, the ranked list acts as a set of recommendations. Optionally, the list displayed to the user may include a suitability score for each listed product or service, which would be a function of utility score and/or purchase probability.

Optionally, the rank list/recommendations may be generated without access to the user's purchase history. Thus, in certain embodiments, because the process does not need the user's purchase history in order to make recommendations, a user does not have to identify herself or log in to her purchase account. However, optionally, the user's purchase history or those of similar consumers may be used in generating recommendations.

Optionally, a report may be generated which indicates what product attributes the process has determined are important and what product attributes are unimportant to the user. An importance rating or score may be assigned for a given attribute. The relative importance of each attribute for each consumer follows directly from the utility function which best fits that individual's choices in certain embodiments. Attributes that impact overall utility to a greater extent have greater importance, and attributes that have little or no impact on overall utility scores have little or minimal importance. By way example, if one considered only nine snack attributes rated on a continuous 0-1 scale, and if Healthiness has a weighting of 0.5 while the other eight attributes are equally weighted at 0.0625 each (note that the weightings sum to 1), then Healthiness has an importance of 50%, while each of the remaining eight snack attributes has an importance of 6.25%. Note that the importances sum to 100%.

A given rule may incorporate different predicted or inferred preferences of a user with respect to different features of a product or service, and may apply different weightings to such features. Thus, the rules may take into account the different tradeoffs a user may make with respect to various feature tradeoffs. For example, with respect to houses, a user may desire both a large grassy area for children to play in, as well as a pool. However, the user may value the large grassy area more than the pool. Therefore, with all other features being equal, a rule for that user may rank a house with both a pool and large grassy area highest, a house with a large grassy area but without a pool second highest, and a house with a pool but without a large grassy area third highest, and a house without a pool and without a large grassy area fourth highest. The foregoing is a simplified example. A more complex example with respect to houses may address dozens or hundreds of tradeoffs (e.g., price, property tax, school district, size, location, number of bedrooms, number of bathrooms, number of en suite bedrooms, basement, attic, type of garage (e.g., attached, detached, subterranean garage), number of cars that can park in garage, guest house, number of fireplaces, style, type of air conditioning, type and quality of views, floor plan type (open or closed), etc. The potential scoring rules may be of the simple linear additive form, or can include multiplicative and exponential elements as well as interactions between attributes.

Certain embodiments select and suggest choices to a user to reduce or minimize the number of selections the user needs to perform in order for the system to provide a recommendation with sufficient accuracy to the user. This enables certain embodiments to provide such unique recommendations to hundreds, thousands, or more users substantially simultaneously and with reduced effort.

Thus, certain embodiments disclosed herein assist users with respect to complex decisions by adaptively measuring a user's preferences and rapidly identifying, in substantially real time, a rule that reflects those preferences and that incorporates the tradeoffs the user would or is likely to make, and ranking applicable products and services using the rule. Example embodiments will be further disclosed below.

Certain embodiments utilize principles of conjoint analysis, in which products are treated as bundles of varying attribute levels, and principles of “design of experiments” (DOE), with specific bundles chosen so as to balance the appearance of the various levels across all the bundles while also ensuring small or minimal correlations (large or maximal orthogonality) between attributes. Unlike conventional DOE, in which the attribute level bundles are hypothetical and only approximate actual products, certain embodiments herein utilize a statistical clustering of actual products to generate an experimental design that is nearly or substantially balanced and orthogonal, while still preserving realism. Many of the embodiments can also use theoretical bundles of attributes as in conventional DOE, at the expense of some degree of realism.

An example application of DOE will now be described. A user may be offered a choice of two or more real, existing products associated with a set of attributes. The attributes may be entirely or significantly orthogonal in that a given attribute is uncorrelated with another attribute. For example, the diagonal size of a television may be independent of the number of inputs it has (e.g., HDMI, RGB, inputs). Because of this orthogonality, it is easier to determine contrasts, and each attribute may be treated independently with respect to other attributes. The attribute levels may be balanced in that they are fairly evenly distributed among products of the type being evaluated. The use of fractional-factorial DOE enables the effects and possible interactions of several factors (e.g., independent variables) to be evaluated while utilizing only a fraction of the runs specified by a full factorial approach.

An example process for generating real product conjoint stimuli will now be described, wherein an orthogonal balanced design is approximated. First, a bundle of attributes is defined. For example, for a television, the attributes may include price, diagonal size, number of HDMI inputs, display type, number of pixels, 3D, thickness, internet access, etc. The process then accesses data for available television sets (which could include dozens, hundreds, or even thousands of different television models) and statistically clusters them. By way of illustration different clusters may be defined for different combinations of attributes. Clustering is performed so that objects in the same cluster are more similar (in at least some sense) to each other than to those in other clusters. The process will then identify televisions that have those attributes. Optionally, the process will identify television models that have similar attributes and assign them to a cluster. Attribute levels may be discretized versions of the actual levels. The clustering algorithm may take into account the relative popularity or market share of each existing product, but this share-based weighting is not required in certain embodiments. Clusters can also comprise of similar products just based on their attribute levels, without regard to units sold. By way of illustration, one cluster may be 3D televisions that are 50 inches diagonal, wherein televisions within the range 49-51 inches diagonal are treated as 50 inches diagonal. The process then maps the television models to the cluster, which may correspond to theoretical conjoint “cards,” where a card corresponds to a bundle of attributes.

The number of clusters used may be based in whole or in part on the range of the number of stimuli needed or desired, the resolution desired in providing recommendations, and/or the number of questions that is to be asked to a user in order to provide the user with a product recommendation. For example, the fewer choice-based tasks that are desired to be asked of a given user, the fewer clusters may be used so that more television models are assigned to a given cluster. In addition, additional clusters may be used to provide higher resolution for features that appear to be of greater interest to consumers (e.g., as measured by sales volume of corresponding television sets). For example, if television models in the range of 48 inches to 52 inches diagonal are very popular, then a separate cluster may be used for each size (e.g., a separate cluster may be used for each of the following sizes: 48 inches, 49 inches, 50 inches, 51 inches, 52 inches). The importance of features may also be determined via interviews with consumers via “Voice of the Customer” methods. For example, consumers may be asked whether size, thickness of bezel, use of LED backlighting, number of ports, number of pixels, etc. is important to them, and based at least in part on the responses, the clustering may be performed. The survey response and sales volume information may also be used to establish prior weights on attribute levels so as to reduce the burden on each individual or to improve the accuracy of recommendations.

Cluster analysis is then performed on the various clusters, and models near or within a threshold of the respective cluster centroids are selected to approximate a balanced orthogonal DOE. For example, the cluster analysis may be performed using Agglomerative Hierarchical Clustering (AHC), (a bottom-up clustering method where clusters may have sub-clusters, which in turn may have sub-clusters, etc.), K-means (a cluster analysis method, which partitions or attempt to partition n observations into k clusters in which each observation belongs to the cluster with the nearest mean to thereby partition the data space into Voronoi cells), or other clustering techniques. Optionally, clustering may be performed to minimize intra-cluster variance and to maximize inter-cluster variance.

In this example, where the product type is television, a representative television model may be selected from each cluster. For example, the most representative product within each cluster using multiple criteria, such as, by way of example, popularity (e.g., as measured by unit sales), distance from centroid, and/or perceived representativeness (e.g., wherein in certain models may be very well known and/or considered iconic of its type). Thus, the representative product may not be the one closest to the centroid. By way of example, an ACME brand television may be closest to the cluster centroid (and thus theoretically the most representative of the cluster), but may not be selected as being representative of the cluster because consumers are not familiar with the brand (even though it is possible an ACME brand television will end up being recommended to a consumer).

Once representative models are selected from respective clusters, the selected representative models, or a subset thereof, will be selectively presented to a user in discrete choice sets (e.g., as a set of DOE cards). The groups may be adaptively formed as described elsewhere herein. The user will then be asked for one or more groups to select the most preferred model, or the least preferred model, or both the most preferred model and the least preferred model. The number of groups and the models included in a group presented to the user may be based at least in part on earlier selections made by the user.

An example embodiment utilizes an Adaptive Best-worst Conjoint (ABC) technique and/or a Conjoint Adaptive Ranking Database System (CARDS) technique to adaptively select what choices (groups) are to be presented to a user. Using such technique, in conjunction with the clustering techniques discussed herein, a recommendation process may surprisingly be able to generate accurate recommendations for a user for thousands of products or services, each with dozens of attributes, while asking the user very few questions (e.g., 1-10 questions, 3-7 questions, or 4-6 questions).

An example Adaptive Best-worst Conjoint (ABC) process will now be described. In the following description, the phrase “cards” for stimuli is used. By way of example, a card may correspond to a real product or service with an associated bundle of attributes. For example, with respect to a television, a card may include the name of the television manufacture, a model number, price, diagonal size, number of HDMI inputs, display type, number of pixels, 3D, thickness, and internet interface.

The user will be presented with multiple cards from which user is to choose the most preferred (the “best”) and the least preferred (the “worst”). In the following example, only 16 cards are used. However, other applications may use fewer or additional cards. Certain embodiments optionally limit the number of cards/stimuli to between 16 and 32 to reduce the number of questions the user needs to answer while still providing sufficiently accurate recommendations. Other embodiments allow many more cards (e.g., 54 cars for snacks in an example embodiment, or over 100 cards for vehicles in another example embodiment) because their adaptive algorithms do not require each individual to view every card.

The 16 cards in this example may include 16 respective products from 16 respective clusters, where a product may be selected to represent a cluster as similarly discussed elsewhere herein. Alternatively, the 16 cards may be based on hypothetical bundles of attributes from a DOE that is both orthogonal (no correlations between attributes) and balanced (attribute levels appear with equal frequency) or, as discussed above, nearly or substantially balanced and orthogonal. In either case, the 16 cards may be utilized to provide rank-ordered recommendations selected from hundreds or thousands of products. Further, the product recommended to the user may be from one of the 16 clusters, but may not actually have been presented to the user as one of the choices.

State 1: Given n cards, there are n(n−1)/2 pairs of cards. The process generates a list of possible pair combinations (e.g., all possible pair combinations). The process generates, and optionally makes a list of such pairs. For example, with 16 cards, applying the foregoing formula, the process generates 120 pairs (1-2, 1-3, . . . , 15-16). There may be a conjoint for each possible pair.

State 2: Optionally, a certain number of choice questions may be presented to the user in a fixed, predetermined manner (where the choices presented in the question are not adaptively based on choices the user made in response to previous choice questions), and a certain number of choice questions may include adaptively generated choices (where the choices presented in the question are adaptively based at least in part on choices the user made in response to one or more previous choice questions). For example, optionally the first n/4 questions, in this example 16/4=4 questions, may be fixed (optionally with each of the n cards presented in at least one choice question). Each of the four questions in the first series of questions may present a set 4 cards to the user, and the user may be asked to select a best card and a worst card for each set. In this example, the user's answers to the first four questions will identify 4 bests, 4 worsts, and 8 middles (which were not chosen as the best or worst).

For example, the user may be presented with the cards as follows:

Question 1: Cards 1, 5, 9, 13

Question 2: Cards 2, 6, 10, 14

Question 3: Cards 3, 7, 11, 15

Question 4: Cards 4, 8, 12, 16

If, in response to question 1, the user selects Card 1 as the best and Card 5 as the worst, and in response to question 2, the user selects Card 2 as the best and Card 14 as the worst, and in response to question 3, the user selects Card 7 as the best and Card 11 as the worst, and in response to question 4, the user selects Card 16 as the best and Card 4 as the worst, then Cards 1, 2, 7, 16 are identified as “bests”, Cards 5, 14, 11, 4 are identified as “worsts”, and Cards 3, 6, 8, 9, 10, 12, 13, 15 are identified as “middles”.

Optionally, fewer or additional questions may include fixed questions.

State 3: The process then adaptively selects choices for the second series of questions based at least in part on the choices the user made in response to the first series of questions. For example, the next series of questions may include n/4 questions, although fewer or additional questions may be used. In this example, the process selects 1 best card, 2 middle cards, and 1 worst card for each choice question.

State 4: The second series of choice questions are presented to the user. For example, the choice questions may be as follows:

Question 5: Cards 1, 10, 15, 4

Question 6: Cards 2, 8, 9, 11

Question 7: Cards 7, 12, 6, 14

Question 8: Cards 16, 3, 6, 5

The user may again be asked to select the best and worst with respect to the choices presented by each selection.

State 5: Each of the initial 8 questions asked at states 2-4 resolved 5 distinct pairs. For example, with respect to question 1, from the user's answer it is determined that the user prefers card 1 over card 9, card 1 over card 13, card 1 over card 5, card 9 over card 5, and card 13 over card 5. Thus, in this example, we have determined the user's preferences with respect to 40 pairs (8 questions×5 pairs resolved/question) out of the 120 possible pairs. An indication as to which pairs of cards are resolved and, in a given pair, which card the user prefers, is stored in a data store, such as a database.

Optionally, additional pairs may be resolved by applying transitivity. A relation is transitive if when A is related to B and B is related to C, then A is related to C. For example, if, via the foregoing questions, it is determined that the user prefers card 1 over card 15, and card 15 over card 11, then the process can infer that the user will or is likely to prefer card 1 over card 11. An indication as to which pairs of cards are resolved via transitivity, and, in a given pair, which card the user prefers, is stored in the data store.

Even with transitivity applied, many pairs may still remain unanswered at this point. Optionally, the process analyzes the pairs not yet resolved and adaptively assembles additional sets of 4 of the 16 cards to resolve the unresolved pairs in an efficient, and optionally most efficient way so as to resolve the greatest number of unresolved pairs (where the user has not yet provided an indication as to which of the pair the user prefers). Based on the analysis, the process generates the next question and stores the user's choices.

State 6. The process of state 4 may be repeated, where the next choice question is based at least in part on previous choice(s) of the user. The process may continue repeating state 4 until all or a desired number/percentage of the card pairs are resolved. Optionally, if there is a tie between 2 cards, which the user appears to prefer neither over the other, one card may be arbitrarily designated as preferred with respect to the other card.

Optionally, in addition to or instead of the one or more of the techniques described above, card pairs may be resolved via a consistency analysis, described below.

As noted above, CARDS may be used instead of or in addition to ABC. A CARDS database may include multiple records, one per scoring rule, wherein each row includes a rank ordering of the stimuli/CARDS according to that record's rule. In the example embodiment, the CARDS database of possible rules can derive from simulated people generated from a population observation using a population algorithm which determines means, variances, and covariances with respect to their relative weightings on each of the product attributes. In other words, if the distribution of population heterogeneity of preference is measured in advance, simulated consumers can be drawn from that distribution and allocated to rows of the CARDS database. The process can control the number of errors in violation of each possible scoring rule allowed prior to eliminating that record (e.g., 0 errors, 1, error, 2 errors, etc.).

The following example illustration of an application of CARDS will refer back to the example above with respect to the application of ABC. Consider the same 16 cards as discussed above. If the “scoring rule” (utility function) for a user is known, that scoring rule maps to a unique ordering of the cards. If there are 16 cards, there are 16! possible orderings, and 16! possible rows in the CARDS database. But more than 99% of the rows do not map perfectly or sufficiently to any reasonable scoring rule. That is, at least one pair of cards would be out of order, or “inconsistent,” with any reasonable scoring rule. These types of errors have been an accepted part of conventional conjoint analysis, however certain embodiments of CARDS eliminates or significantly reduces these violated-pair errors and thereby both greatly speeds up the conjoint analysis process and significantly improves its quality. Thus, a given scoring rule implies a specific card order, and a specific card order that is perfectly consistent maps to a particular scoring rule among the records in the CARDS database. The scoring rule and the card order map to each other, and each such mapping is assigned a row in the CARDS database.

The CARDS application process will now be applied to an example set of 16 stimuli/cards.

State 1: Optionally all (or substantially all) orderings which do not perfectly map to a utility function are eliminated from the CARDS database to ensure the orderings are consistent. For 16 cards, typically <1% of the 16! possible orders are consistent, so the vast majority of possible card orderings are eliminated in advance because they include consistency errors. The CARDS algorithm starts with a listing, which may be in the form of database, including the consistent orderings. The list may be a vector of 16 card numbers in order from best to worst (or worst to best) according to a particular scoring rule, where each such vector answers all or substantially all n(n−1)/2 paired comparisons. The term “inconsistent,” in this example refers to a particular pair of cards that are chosen by an individual in reverse order of preference, in contradiction to the best-fit scoring rule that explains the remainder of that individual's choices. These types of inconsistency errors are very common in discrete choice experiments.

State 2: As similarly discussed above with respect to the example application of ABC, when a set of 4 cards are present to a user, and the user indicates which is the best/most preferred card and which is the worst/least preferred card, 5 of the 6 possible pairs in that question will have been directly answered/resolved. Those 5 paired answers can be compared against the CARDS database to identify which rows in the database have those 5 pairs in the same order. Other rows may be eliminated or marked as not relevant from the database. In this example, approximately 1/32=(½)̂5 rows of the database will remain at the end of each question. Optionally, historical responses to questions from other users may be taken into account is selecting the 4 cards to present to the user. For example, if a certain percentage of other users (e.g., greater than 50%, greater than 75%, or other threshold) identify a first television as a most preferred television, and a certain percentage of other users (e.g., greater than 50%, greater than 75%, or other threshold) identify a second television as a least preferred television, then the set of cards may include cards corresponding to the first television and the second television, and the other cards may optionally be chosen randomly.

State 3: In addition, as similarly discussed above with respect to the application of the ABC technique, transitivity may be applied to identify extra paired comparison answers, which may be used to eliminate still additional rows in the database.

State 4: At this point, if the CARDS technique is combined with the ABC technique, then the ABC adaptive algorithm may be used determine the next 4 cards to show the user, and more database rows will be eliminated, and so on, optionally until only one row is left. When the ABC technique is combined with the CARDS technique, unanswered pairs may be resolved on the basis that no rows remain in which Card 1>Card 2. Thus, in this example the database of all possible paired comparisons is scanned after the individual makes each choice, and records where those paired comparisons have been violated are eliminated. Thus, ABC and CARDS use a process of elimination to rapidly converge to the scoring rule (e.g., a single scoring rule) that fits the observed choices.

State 5: If the CARDS technique is applied without utilizing the ABC technique, an adaptive algorithm may be used determine which 4 cards to show the user next. For example, the adaptive algorithm may scan rows in the CARDS database which have not been eliminated from consideration to determine which 4 cards are expected to eliminate the greatest number of rows based on the individual's next choice. In an example embodiment, the adaptive algorithm identifies the greatest number of reversals of pairs in the rows. For example, if Card 4 and Card 7 appear 4-7 (4 preferred over 7) in half of the remaining rows (indicating that the item corresponding to Card 4 is preferred over the item corresponding to Card 7 based on that record's scoring rule), and 7-4 (7 before 4) in the other half of the remaining rows (indicating that the item corresponding to Card 7 is preferred over the item corresponding to Card 4), then Cards 4 and 7 are good candidates to be included in the next question as the user's choice may eliminate half the rows. For example, if the cards presented to the user include Card 4 (which may correspond to a first television set) and Card 7 (which may correspond to a second television set), and the user selects Card 4 (the first television set) as the best/most preferred of the 4 cards and selects Card 7 (the second television set) as the worst/least preferred card, then the half of the rows/combinations where Card 7 is listed as more preferred than Card 4 can be eliminated.

To simplify programming, optionally, an array may be instantiated where the first column contains all of the pairings (120 pairs if there are 16 cards, as in state 1 of the ABC process described above), and the next two columns of the array are respectively left card-beats-right card and left beats right. The values in this array may be counts from the database and a measure of how far apart they are in the rank orderings in the remaining records. Four cards are selected which minimize a mathematical function of the absolute differences in the last two columns, so that the cards selected for presentation will, if selected by the user as a best card or worst card, eliminate a large number of rows. Thus, in certain embodiments it may be advantageous to adaptively create the next choice set so as to resolve the greatest amount of uncertainty (or a relatively high amount of uncertainty), which is directly related to eliminating the greatest number of remaining records. If a particular card appears to dominate most other cards, or to be dominated by most other cards, it is less likely to appear in the next choice set. The CARDS process may continue selecting cards and posing questions to the user until only one row remains. Even if the user does not follow the process to its end, in which only one record remains, the subset of records remaining at any given point can be combined to estimate a scoring rule with some level of precision.

State 6: Even if 99% of the rows are eliminated, the remaining rows (1% of 16!) is on the order of ˜200 billion, and so there is still a large number of rows to eliminate. Using conventional techniques to reduce the number of rows would require asking the user to make such a large number of choices that the typical user would be unable or would refuse to make such choices. Therefore, certain embodiments utilize one or more techniques to significantly reduce the size of the database, and thereby reduce the number of questions that need be posed to the user. For example, certain embodiments reduce the number of rows by reducing the resolution of choices. The number of database rows may be referred to as the “resolution” of the database. Thus, there is a tradeoff between the questioning burden placed on users and the level of resolution of the database. By way of illustration, assume that the database includes fewer than 1 million rows, each with 16 card numbers in order, with a corresponding scoring rule stored for each row. For example, a scoring rule may have nine coefficients based on consumer priorities for attributes in that product category.

The attribute levels may be mapped or normalized so that the levels are comparable between products and within a product. For example, the attributes may be normalized to a continuous 0 to 1 scale, although other scales may be used (e.g., 1-5, 1-10, etc.). Then, real products are used as conjoint stimuli.

By way of illustration, assume that there is a scale of 1-10 that can compare each television on diagonal size. In order to reduce the database resolution, and hence the database size, rather than have attributes 19 inches, 20 inches, 23 inches, 24 inches, 30 inches, 40 inches, 45 inches, 50 inches, 63 inches, and 65 inches, utilize terms such as “large”, “medium”, and “small”. Thus, rather having to account for 10 different sizes, only three sizes need be accounted for. This is also related to the prior discussion of the number of clusters created for actual products. Either reducing the number of attribute levels or the number of clusters greatly reduces the number of combinations, and therefore the number of database rows and size.

As noted above, a product's attributes may include subjective criteria, such as beauty. Conventionally, it is much more difficult to gather subjective information regarding a product than objective information (such as sales, size, number of ports, cost, calories, etc.). However, such subjective information may, for certain users, be an important consideration in the desirability of a product. Thus, for such users, it may be helpful to determine what type of user they are with respect to subjective attributes. For example, some users may not care about beauty at all, while for some users beauty may be a very important consideration. Further, some users may prefer something that looks “modern” while some users prefer something that looks traditional. In order to collect such information, certain embodiments conduct surveys of users. However, conventional surveys tend to be tedious and onerous for surveys participants.

In contrast to conventional surveys, certain embodiments encourage users to participate in surveys by turning the surveys into a game. Survey participants allocate 100 points, for example, across three or four products or services based on their personal perception of beauty (or any other subjective attribute), and may be offered rewards for guessing or estimating what other people would subjectively think or value regarding certain attributes in order to create subjective attribute levels. A survey participant's reward may correspond at least in part with how accurately the participant guesses how other people will value a given product, service, or attribute. Measuring the accuracy of a participant's guess about others' preferences may be accomplished by, for example, calculating the r-squared or mean absolute error, to name just two of many possible metrics, between the participant's guesses and the mean or median of the actual responses given by the crowd in the same survey. The reward may be products or services (e.g., movie tickets, content downloads (e.g., audio or video download), or in the form of points which may be used to obtain products and/or services from a catalog (e.g., an online catalog). Thus, certain embodiments employ a preferences of crowds game in order to obtain subjective, unobservable information from large numbers of people.

For example, a participant may be presented with an image of four snacks and be asked to allocate 100 points across all four based on how tasty the participant thinks each snack is and/or how tasty the participant thinks other consumers would find each snack. The survey may be presented to the user online, via a web page, a phone application, or otherwise.

With respect to medical treatment, subjective attribute values may be obtained from interviews with patients and doctors using “Voice of the Patient” methods.

Thus, advantageously, a DOE may be generated to determine values for hundreds or thousands of products while only asking the user to evaluate relatively few products (e.g., 10 or less, or 20 or less products).

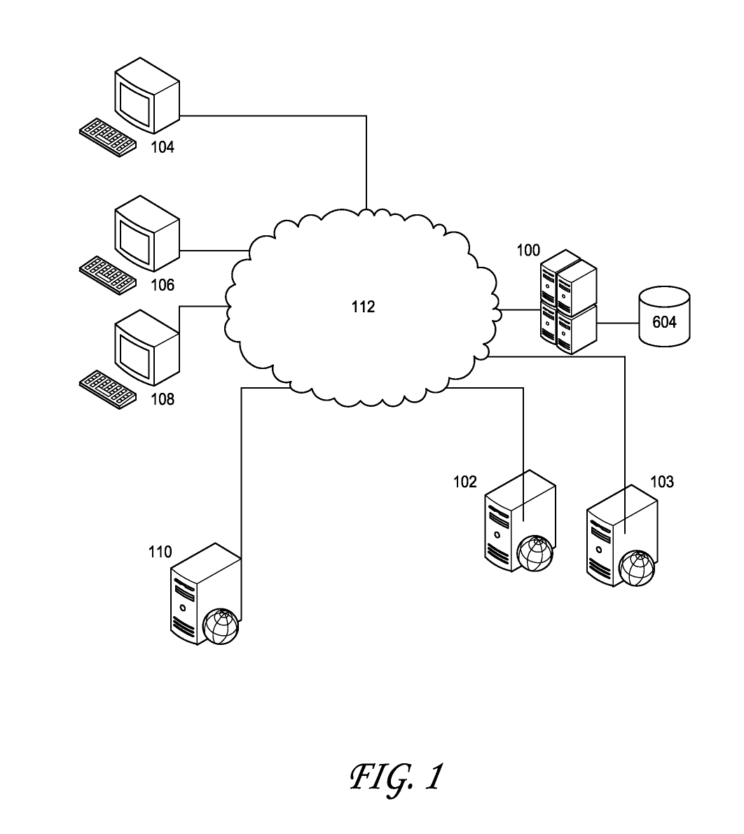

Referring now to the figures, FIG. 1 illustrates an example architecture. A recommendation system 100 includes a data store, which may be in the form of a database. The recommendation system 100 may be coupled over a network to one or more other external systems 102, 103 including respective data stores (e.g., databases). The external systems may store and provide data such as unit sales data for products and/or services, and attribute/specification data for products and/or services. The recommendation system 100 or another system may include a survey system that generates surveys to collect and store subjective attribute valuations. In addition or instead, the recommendation may be coupled to receive data from a third party survey system 110 to access such data.

The recommendation system 100 may utilize the various data types to generate recommendations as described herein. The recommendation system 100 may be coupled to one or more user terminals 104, 106, 108. The recommendation system 100 may transmit user interfaces to the user terminals 104, 106, 108 and receive user input via the user terminals 104, 106, 108, as discussed elsewhere herein. For example, the recommendation system 100 may provide user interfaces asking the user to choose between various products/services, and based at least in part on the user's selections, generate and provide ranked recommendations and/or reports based at least in part on the importance the recommendation system 100 determined that the user places on different product attributes. The foregoing systems and terminals may be connected via one or more networks 112 (e.g., the Internet, an intranet, etc.).

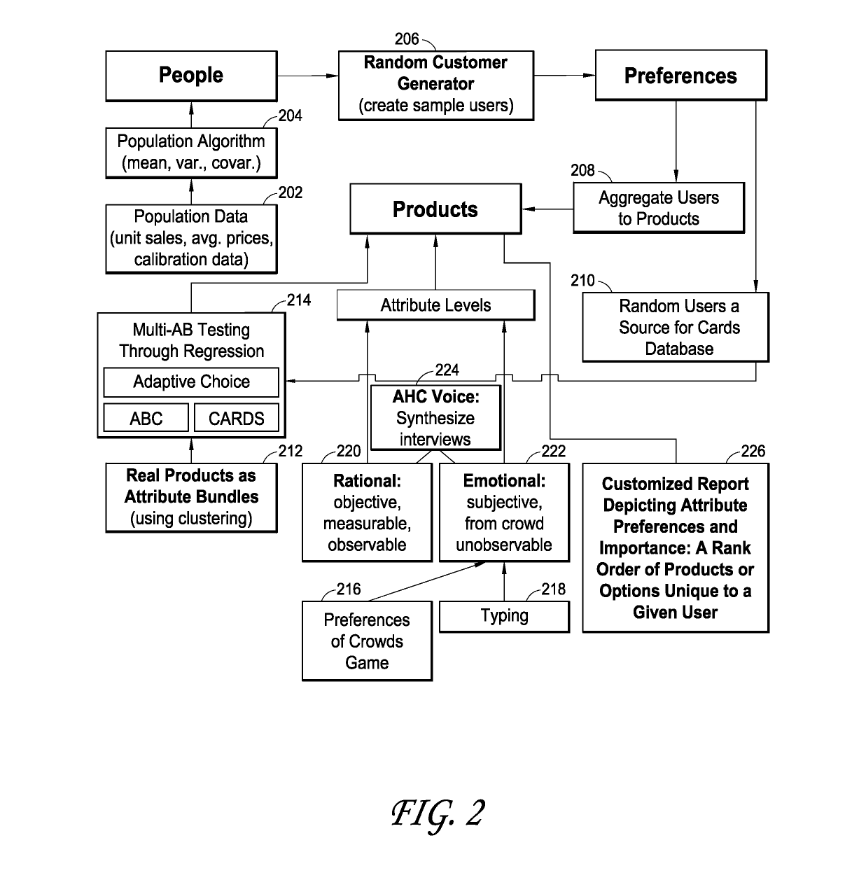

Referring now to FIG. 2, an example process for generating references for a given item type is illustrated. At state 202, population data in input by the recommendation system from one or more sources. The population data may include unit sales, average prices, and choice calibration data used to calibrate population level purchase data. The population data may derive from observable marketplace data, and the calibration data may be collected through surveys of individuals making choices. By way of example, calibration data may be obtained from one of the embodiments in which an individual makes best and worst choices from sets of discrete choices. For example, if the item type is televisions, the population data for the population of television buyers (e.g., of many or all different models of televisions) may include the number of unit sales over a specific period of time, for a specific geographical region, and the average or median sales price. Optionally, the process updates the population data periodically (e.g., monthly) and/or in response to a specific type of event to identify new trends in the desirability of certain features. A population algorithm may then analyze the population data (e.g., using statistical analysis to determine the mean and variance, of weightings on each attribute and for each attribute level, and the covariances between attributes). For example, the population data may be processed using an accelerated heterogeneity algorithm, which performs a statistical analysis that estimates covarying bell curves for respective product characteristics.

At state 206, a random customer generator generates prototypical customers for the item type. At state 208, using the bell curve distribution generated at state 204, the process uses a scoring rule/utility function to allocate the probability a simulated, prototypical person would purchase the item. The process may generate tens, hundreds, thousands, or even more simulated people. The utility function may be weighted by the probability the user would purchase the item, optionally with a variance (e.g., a 60% probability that the user will purchase the item with a 5% variance). Multiple prototypical people may be folded into a given utility function. At state 210, the random users' scoring rules/utility functions may be used as a source for the CARDS database.

At state 212, real products may be used as attribute bundles, as discussed elsewhere herein. At state 214, multi-AB testing through regression may be performed using adaptive choice (e.g., ABC, and/or CARDS).

At state 216, a preferences of crowds game may be instantiated to collect subjective information from significant numbers of people, as similarly described elsewhere herein. At state 218, a subjective typing operation may be performed as discussed elsewhere herein. At state 224, attribute values may be obtained via interviews (e.g., using Agglomerative Hierarchical Clustering voice of the customer).

The results of states 216, 218, and 224 may be used at state 222 to determine, at least in part, subjective/emotional attribute levels. Optionally, the results of state 224 may be used at state 220 to determine, at least in part, rational (e.g., objective, measurable, observable) attribute levels. At state 226, a customized report may be generated, depicting attribute preferences and importance. Based at least in part, on some or all of the foregoing analysis and information, a rank order of items or options unique to a given user may be generated and provided to the user.

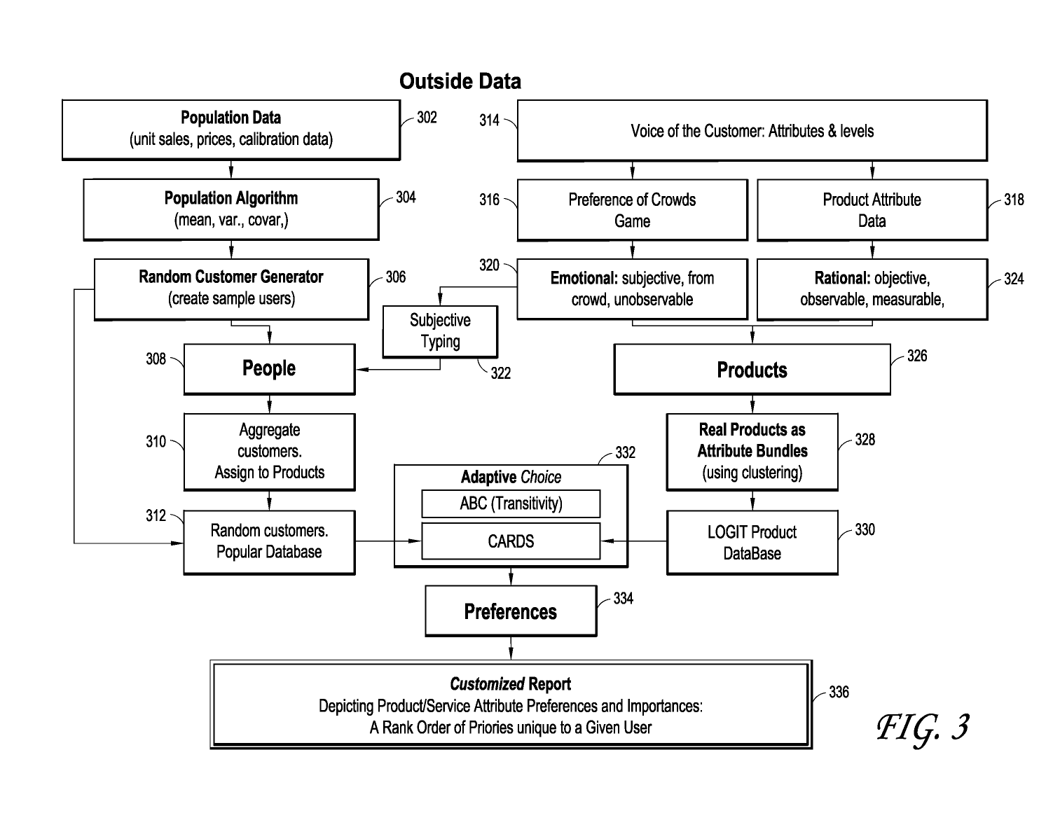

FIG. 3 illustrates another embodiment of an example process for generating references for a given item (e.g., product or service) type. At state 302, population data is input by a recommendation system from one or more sources. The population data may include unit sales, price information (e.g., average prices), and choice calibration data used to calibrate population level purchase data. The population data may derive from observable marketplace data, and the calibration data may be collected through surveys of individuals making choices. At state 304, a population algorithm, executed by the system, may then analyze the population data (e.g., using statistical analysis to determine the mean and variance, of weightings on each attribute and for each attribute level, and the covariances between attributes). For example, the population data may be processed using an accelerated heterogeneity algorithm, which performs a statistical analysis that estimates covarying bell curves for respective item characteristics. At state 306, a random customer generator creates/defines sample users for the given item based at least in part on results from the population algorithm. At states 308, 310, based at least in part on the sample users and the subjective typing of state 322, the process uses a scoring rule/utility function to allocate the probability a simulated, prototypical person would purchase the item. The utility function may be weighted by the probability the user would purchase the item, optionally with a variance. Multiple prototypical people may be folded into a given utility function. At state 312, the random users may be used as a source for the CARDS database and ABC analysis performed at state 322.

At state 314, voice of the customer interviews and the like may be used to select attributes and assign associated attribute levels. At state 316, a preferences of crowds game may be instantiated to collect subjective information from significant numbers of people, as similarly described elsewhere herein. At state 318, item attribute data may be defined using interview results. The results of states 314 and 316 may be used at state 320 to determine, at least in part, subjective/emotional attribute levels. Optionally, the results of state 318 may be used at state 324 to determine, at least in part, rational (e.g., objective, measurable, observable) attribute levels. At state 326, based at least in part on the results of states 320 and 324, the item(s) may be portioned into a set of objective and/or subjective attributes. At state 328, optionally real items may be used as attribute bundles, as discussed elsewhere herein. At state 330, the item database may be populated using the prior results. At state 332, multi-AB testing through regression may be performed using adaptive choice, ABC, and/or CARDS, as similarly discussed elsewhere herein. At state 334, based at least in part on the results of state 332, the user's item preferences may be determined. At state 336, a customized report may be generated, depicting attribute preferences and importance, optionally including a rank order of items or options unique to the given user.

Certain example user interfaces may ask a user choose between various items of a given item type (in this example, snacks, cars, and prostate cancer treatments), and provide recommendations and a report analyzing what attributes the user finds important.

An example aspect provides a method of providing item recommendations, wherein an item is an existing product and/or an existing service, the method comprising one or more of the following: generating a set of stimuli for a first item type, said generating comprising: identifying a first plurality of items, comprising a plurality of actual products or services, corresponding to the first item type; identifying a set of attributes associated with the first item type; identifying levels corresponding to at least a portion of the attributes for the first plurality of items; grouping items in the first plurality of items into a plurality of subsets of items according to one or more attributes and/or levels; selecting from a given subset of items a representative item to be used as user stimuli; generating a plurality of utility functions in which a given attribute in the first set of attributes is associated weighting indicating the relative importance of given attribute to a respective simulated consumer, wherein generating the plurality of utility functions is performed using at least one or more of the following: random generation of vectors of utility weighting coefficients, or vectors of attributes of at least a portion of the items in the first plurality of items, or sales data for at least a portion of the items in the first plurality of items; selecting a first set of items to be presented to a user, the first set including representative items from respective subsets of items; causing the first set of items to be presented to a user; receiving an indication from the user as to: which item in the first set of items is a most preferred item, or which item in the first set of items is a least preferred item, or which item in the first set of items is a most preferred item and which item in the first set of items is a least preferred item; using adaptive best-worst conjoint and/or conjoint adaptive ranking to adaptively select a second set of items to be presented to a user; receiving an indication from the user as to: which item in the second set of items is a most preferred item, or which item in the second set of items is a least preferred item, or which item in the second set of items is the most preferred item and which item in the second set of items is the least preferred item; based at least in part on the received user indications, selecting a utility function from the plurality of utility functions; and/or generating respective ranking scores for some or all of the first plurality of items using the selected utility function; providing for display to the user ranking information for a plurality of items in the first plurality of items based at least in part on the ranking scores.

Optionally, the act of grouping items in the first plurality of items into the plurality of subsets of items according to one or more attributes and/or levels further comprises using design of experiments clustering to select items in the first plurality of items for a given subset of items based at least in part on orthogonality and balance criteria. Optionally, the act of grouping items in the first plurality of items into the plurality of subsets of items according to one or more attributes and/or levels further comprises using design of experiments clustering to select and cluster items in the first plurality of items for a given subset of items based at least in part on orthogonality and balance criteria, wherein the representative item to be used as user stimuli is not closest to the center of the cluster relative to other items in the cluster. Optionally, the set of attributes includes objective attributes and subjective attributes. Optionally, the set of attributes includes objective attributes and subjective attributes, the objective attributes including at least physical dimension attributes, and the subjective attributes including at least aesthetic appearance.

Optionally, generating the plurality of utility functions is performed using vectors of attributes of at least a portion of the items in the first plurality of items, without reference to units sold data for the at least portion of items. Optionally, generating the plurality of utility functions is performed using sales data, including sales volume and price data, for at least a portion of the items in the first plurality of items. Optionally, generating the plurality of utility functions is performed using sales data, including sales volume and price data, for items in the first plurality of items. Optionally, adaptively selecting the second set of items to be presented to a user further comprises selecting items that resolve a greatest number of unresolved pairs, among possible pairs, of items.

Optionally, the method further comprises: mapping respective utility functions in the plurality of utility functions to respective rank orderings of the first plurality of items based at least on respective utility scores; mapping rank orderings to a set of approximately n×(n−1)/2 paired comparisons for a set of n stimuli, wherein a given stimuli corresponds to an item in the first plurality of items; storing a given utility function in association with a respective rank ordering and paired comparisons of stimuli; selecting as stimuli, to provide for display to the user, to resolve a substantially greatest number of unresolved pairs; inhibiting consideration of utility functions in the plurality of utility functions for use in determining ranking information to be displayed to the user that rank items so as to include rankings that conflict by more than a first threshold with one or more indications from the user related to user preferences with respect to stimuli presented to the user. Optionally, the method further comprises: determining approximately n×(n−1)/2 possible paired comparisons for a set of n stimuli, wherein a given stimuli in the set of n stimuli corresponds to a respective item in the first plurality of items; resolving the approximately n×(n−1)/2 possible paired comparisons based at least in part on the user indications of the most preferred of q alternatives, or the least preferred of q alternatives, or the most and least preferred of q alternatives to determine the user's preferences among the q×(q−1)/2 possible pairs for a given set of items provided for presentation to the user; selecting items to be included in a further set of stimuli to substantially maximize a quantity of pairs that will be resolved in response to user indications of the most preferred, or the least preferred, or the most and least preferred of items in the further set of stimuli.

Optionally, the method further comprises: determining the user's preferences with respect to first and second items in a given pair of items, without presenting the given pair of items to the user, based at least on a previous preference indication from the user with respect to the first item when paired with an item different than the second item utilizing transitivity: Optionally, the method further comprises: determining a level for at least a first subjective attribute for a given item based at least in part on responses from a sample of consumers, wherein a given response from a given consumer in the sample of consumers includes an indication as to whether the given consumer likes or dislikes the first subjective attribute of the given item and an indication as to whether the given consumer thinks other consumers would like or dislike the subjective attribute of the given item.

While the above disclosure may refer to providing recommendations for a particular product, such as televisions, the foregoing processes and systems may be utilized to provide recommendations for other products and services, such as houses, medical treatments, clothing, snacks, vehicles, insurance plans, vacations, etc.

Unless otherwise indicated, the functions described herein may be performed by software (e.g., including modules) including executable code and instructions running on one or more. The software may be stored in computer readable media (e.g., some or all of the following: optical media (e.g., CD-ROM, DVD, Blu-ray, etc.), magnetic media (e.g., fixed or removable magnetic media), semiconductor memory (e.g., RAM, ROM, Flash memory, EPROM, etc.), and/or other types of computer readable media.

The one or more computers can include one or more central processing units (CPUs) that execute program code and process data, non-transitory, tangible memory, including. for example, one or more of volatile memory, such as random access memory (RAM) for temporarily storing data and data structures during program execution, non-volatile memory, such as a hard disc drive, optical drive, or FLASH drive, for storing programs and data, including databases,” a wired and/or wireless network interface for accessing an intranet and/or Internet, and/or other interfaces.

In addition, the computers can include a display for displaying user interfaces, data, and the like, and one or more user input devices, such as a keyboard, mouse, pointing device, touch screen, microphone and/or the like, used to navigate, provide commands, enter information, provide search queries, and/or the like. The systems described herein can also be implemented using general-purpose computers, special purpose computers, terminals, state machines, and/or hardwired electronic circuits.

While various systems are described herein optionally some are or all of the various systems can be included a single system operated by a single operator.

The example processes described herein do not necessarily have to be performed in the described sequence, and not all states have to be reached or performed.

Unless the context otherwise indicates, the term “field” with respect to a user interface or form is intended to refer to a user entry mechanism via which the user can input data or commands, such as a text field, a menu via which the user can make a selection, etc. While reference may be made to applying certain embodiments with respect recommending and ranking of products, it is understood that such embodiments may be utilized to provide recommendations and rankings with respect to services.

Various embodiments provide for communications between one or more systems and one or more users. These user communications may be provided to a user terminal (e.g., an Interactive television, a phone, a video game system, a laptop/desktop computer, a device providing Internet access, or other networked device). For example, communications may be provided via Webpages, downloaded documents, email, SMS (short messaging service) message, MMS (multimedia messaging service) message, terminal vibrations, text-to-speech message, or other forms of electronic communication, or otherwise.

Although this invention has been disclosed in the context of certain embodiments and examples, it will be understood by those skilled in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

1. (canceled)

2. A method of providing item recommendations, wherein an item is an existing product and/or an existing service, the method comprising:
generating a set of stimuli for a first item type, said generating comprising:
identifying a first plurality of items, comprising a plurality of actual products or services, corresponding to the first item type;
identifying a first set of attributes associated with the first item type;
identifying levels corresponding to at least a portion of the first set of attributes for the first plurality of items;
grouping items in the first plurality of items into a plurality of subsets of items according to one or more attributes and/or levels;
selecting from a given subset of items a representative item to be used as user stimuli;
generating a plurality of utility functions in which a given attribute in the first set of attributes is associated with a weighting indicating a relative importance of given attribute to a respective simulated consumer, wherein generating the plurality of utility functions is performed using at least one or more of the following:
random generation of vectors of utility weighting coefficients, or
vectors of attributes of at least a portion of the items in the first plurality of items, or
sales data for at least a portion of the items in the first plurality of items;
selecting a first set of items to be presented to a user, the first set including representative items from respective subsets of items;
causing the first set of items to be presented to a user;
receiving an indication from the user as to:
which item in the first set of items is a most preferred item, or
which item in the first set of items is a least preferred item, or
which item in the first set of items is a most preferred item and which item in the first set of items is a least preferred item;
using adaptive best-worst conjoint and/or conjoint adaptive ranking to adaptively select a second set of items to be presented to a user;
receiving an indication from the user as to:
which item in the second set of items is a most preferred item, or
which item in the second set of items is a least preferred item, or
which item in the second set of items is the most preferred item and which item in the second set of items is the least preferred item;
based at least in part on the received user indications, selecting a utility function from the plurality of utility functions;
generating respective ranking scores for some or all of the first plurality of items using the selected utility function;
providing for display to the user ranking information for a plurality of items in the first plurality of items based at least in part on the ranking scores.

3. The method as defined in claim 2, wherein the act of grouping items in the first plurality of items into the plurality of subsets of items according to one or more attributes and/or levels further comprises using design of experiments clustering to select items in the first plurality of items for a given subset of items based at least in part on orthogonality and balance criteria.

4. The method as defined in claim 2, wherein the act of grouping items in the first plurality of items into the plurality of subsets of items according to one or more attributes and/or levels further comprises using design of experiments clustering to select and cluster items in the first plurality of items for a given subset of items based at least in part on orthogonality and balance criteria, wherein the representative item to be used as user stimuli is not closest to the center of the cluster relative to other items in the cluster.

5. The method as defined in claim 2, wherein the first set of attributes includes at least one subjective attribute.

6. The method as defined in claim 2, wherein the first set of attributes includes at least one subjective attribute, including at least aesthetic appearance.

7. The method as defined in claim 2, wherein generating the plurality of utility functions is performed using vectors of attributes of at least a portion of the items in the first plurality of items.

8. The method as defined in claim 2, wherein generating the plurality of utility functions is performed using sales data, including sales volume and price data, for at least a portion of the items in the first plurality of items.

9. The method as defined in claim 2, wherein adaptively selecting the second set of items to be presented to a user further comprises selecting items that resolve a greatest number of unresolved pairs, among possible pairs, of items.

10. The method as defined in claim 2, the method further comprising:
mapping respective utility functions in the plurality of utility functions to respective rank orderings of the first plurality of items based at least on respective utility scores;
mapping rank orderings to a set of paired comparisons for a set of n stimuli, wherein a given stimuli corresponds to an item in the first plurality of items;
storing a given utility function in association with a respective rank ordering and paired comparisons of stimuli;
selecting as stimuli, to provide for display to the user, to resolve a substantially greatest number of unresolved pairs;
inhibiting consideration of utility functions in the plurality of utility functions for use in determining ranking information to be displayed to the user that rank items so as to include rankings that conflict by more than a first threshold with one or more indications from the user related to user preferences with respect to stimuli presented to the user.

11. The method as defined in claim 2, the method further comprising:
determining approximately n×(n−1)/2 possible paired comparisons for a set of n stimuli, wherein a given stimuli in the set of n stimuli corresponds to a respective item in the first plurality of items;
resolving the approximately n×(n−1)/2 possible paired comparisons based at least in part on the user indications of the most preferred of q alternatives, or the least preferred of q alternatives, or the most and least preferred of q alternatives to determine the user's preferences among the q×(q−1)/2 possible pairs for a given set of items provided for presentation to the user;
selecting items to be included in a further set of stimuli to substantially maximize a quantity of pairs that will be resolved in response to user indications of the most preferred, or the least preferred, or the most and least preferred of items in the further set of stimuli.

12. The method as defined in claim 11, the method further comprising determining the user's preferences with respect to first and second items in a given pair of items, without presenting the given pair of items to the user, based at least on a previous preference indication from the user with respect to the first item when paired with an item different than the second item utilizing transitivity:

13. The method as defined in claim 11, the method further comprising determining a level for at least a first subjective attribute for a given item based at least in part on responses from a sample of consumers, wherein a given response from a given consumer in the sample of consumers includes an indication as to whether the given consumer likes or dislikes the first subjective attribute of the given item and an indication as to whether the given consumer thinks other consumers would like or dislike the subjective attribute of the given item.

14. A method of providing item recommendations, the method comprising:
generating a set of stimuli for a first item type, said generating comprising:
identifying a first plurality of items corresponding to the first item type;
identifying a first set of attributes associated with the first item type;
identifying levels corresponding to at least a portion of the first set of attributes for the first plurality of items;
generating a plurality of utility functions in which a given attribute in the first set of attributes is associated with a weighting indicating a relative importance of given attribute to a respective simulated consumer;
selecting a first set of items to be presented to a user;
causing the first set of items to be presented to a user;
receiving an indication from the user as to:
which item in the first set of items is a most preferred item, or
which item in the first set of items is a least preferred item, or
which item in the first set of items is a most preferred item and which item in the first set of items is a least preferred item;
based at least in part on the received user indications, selecting a utility function from the plurality of utility functions;
generating respective ranking scores for some or all of the first plurality of items using the selected utility function; and
providing for display to the user information reflective of the ranking scores.

15. The method as defined in claim 14, the method further comprising grouping items in the first plurality of items into a plurality of subsets of items according to one or more attributes and/or levels;

16. The method as defined in claim 14, the method further comprising grouping items in the first plurality of items into a plurality of subsets of items according to one or more attributes and/or levels, using design of experiments clustering to select items in the first plurality of items for a given subset of items based at least in part on orthogonality and balance criteria.

17. The method as defined in claim 14, the method further comprising grouping items in the first plurality of items into a plurality of subsets of items according to one or more attributes and/or levels using design of experiments clustering to select and cluster items in the first plurality of items for a given subset of items based at least in part on orthogonality and balance criteria, wherein the representative item to be used as user stimuli is not closest to the center of the cluster relative to other items in the cluster.

18. The method as defined in claim 14, wherein generating the plurality of utility functions is performed using at least one or more of the following:
random generation of vectors of utility weighting coefficients, or
vectors of attributes of at least a portion of the items in the first plurality of items, or
sales data for at least a portion of the items in the first plurality of items.

19. The method as defined in claim 14, wherein generating the plurality of utility functions is performed using vectors of attributes of at least a portion of the items in the first plurality of items.

20. The method as defined in claim 14, wherein generating the plurality of utility functions is performed using sales data, including sales volume and price data, for at least a portion of the items in the first plurality of items.

21. The method as defined in claim 14, wherein the first set of attributes includes at least one subjective attribute.

22. The method as defined in claim 14, wherein the first set of attributes includes at least one subjective attribute, including at least aesthetic appearance.

23. The method as defined in claim 14, the method further comprising adaptively selecting a second set of items to be presented to the user using adaptive best-worst conjoint and/or conjoint adaptive ranking;
receiving an indication from the user as to:
which item in the second set of items is a most preferred item, or
which item in the second set of items is a least preferred item, or
which item in the second set of items is the most preferred item and which item in the second set of items is the least preferred item.

24. The method as defined in claim 23, wherein adaptively selecting the second set of items to be presented to a user further comprises selecting items that resolve a greatest number of unresolved pairs, among possible pairs, of items.
